(19) United States
(12) Patent Application Publication
(10) Pub. No.: US 2015/0242927 A1
(43) Pub. Date: Aug. 27, 2015

(54) METHOD AND SYSTEM OF AN ONLINE TRAVEL WEBSITE

(71) Applicants: Jason Will, San Francisco, CA (US); Joshua Rasmussen, San Francisco, CA (US)

(72) Inventors: Jason Will, San Francisco, CA (US); Joshua Rasmussen, San Francisco, CA (US)

(21) Appl. No.: 14/222,665

(22) Filed: Mar. 23, 2014

Related U.S. Application Data
(60) Provisional application No. 61/886,065, filed on Oct. 3, 2013.

(51) Int. Cl. G06Q 30/06; G06Q 10/02

(52) U.S. Cl. CPC G06Q 30/0629; G06Q 10/02

(57) ABSTRACT

In one exemplary aspect, a method of an online travel website includes obtaining a list of hierarchal user travel preferences from a first user. Each of the first user's travel preference is weighted based on an order of the first user's travel preference in the list. A first user's query for a list of travel results is received. The list of travel results related to the first user's query is obtained. The list of travel results to identify a travel result attribute related to each of the first user's travel preferences is parsed. Each travel result is scored based on the weight of each related first user's travel preference. The list of travel results is sorted based on a score of each travel result.

### CROSS-REFERENCE TO RELATED APPLICATIONS

This application claims priority to U.S. provisional patent application No. 61/773,145 filed on Oct. 3, 2013. This application is incorporated herein by reference.

### BACKGROUND

1. Field

This application relates generally to computerized travel services, and more specifically to a system, article of manufacture and method of an online travel website.

2. Related Art

Travelers can increasing use online travel services to book travel or transportation services. Accordingly, a traveler's ability to search and review a multitude of travel options as increased as well. A traveler can interact with an online travel service to obtain travel-related information such as a flight's cost, baggage fees, pre-flight amenities at the airport, in-flight amenities, and/or post-flight amenities. All of these interactions can require distinct repetitive actions from the traveler such as repeated searches using different query terms and parameters. For example, a traveler can input one set of search criteria and view the result. In order to determine how a modification to the search criteria changes the results, the traveler may have to perform another search. The complexity of the task can increase drastically when a group of travelers are booking travel plans together. Furthermore, parameters used by an online travel service to rank travel plan search results may be opaque. For example, given a search result, the traveler may not have access to the parameters the online travel service used to rank the particular results. The traveler may take extra steps and time to ensure that certain preferences are available in the options provided.

### BRIEF SUMMARY OF THE INVENTION

In one aspect, a method of an online travel website includes obtaining a list of hierarchal user travel preferences from a first user. Each of the first user's travel preference is weighted based on an order of the first user's travel preference in the list. A first user's query for a list of travel results is received. The list of travel results related to the first user's query is obtained. The list of travel results to identify a travel result attribute related to each of the first user's travel preferences is parsed. Each travel result is scored based on the weight of each related first user's travel preference. The list of travel results is sorted based on a score of each travel result.

Optionally, a list of hierarchal user travel preferences from a second user ca be obtained. Each of the second user's travel preference can be weighted based on an order of the second user's travel preference in the list. The first user can be a higher ranking employee than the second user. The first user's travel preferences can receive a greater weight than the second user's travel preferences. A hover box can be generated that includes a first set of one or more hierarchal user travel preferences from the first user that are associated with the element of the list of travel results when it has been detected that the first user has moved a computer-implemented pointer over a graphical display of an element of the list of travel results.

### BRIEF DESCRIPTION OF THE DRAWINGS

The present application can be best understood by reference to the following description taken in conjunction with the accompanying figures, in which like parts may be referred to by like numerals.

FIG. 1 depicts a screen shot illustrating an example web page of an online travel website.

FIG. 2 depicts a screen shot of the web page of FIG. 1 with the ‘flight dates’ tab selected, according to some embodiments.

FIG. 3 depicts a screen shot of a web page providing input fields (e.g. a tool bar) for a user to provide information including one or more user preferences related, according to some embodiments.

FIG. 4 provides an example of the inputs fields with a specific user's information, according to some embodiments.

FIG. 5 and FIG. 6 depict an example of the web page of FIG. 1 with travel plan results provided according to the user(s) selections and/or preferences, according to some embodiments.

FIG. 7 depicts an example of a hover-over functionality of the travel-service website, according to some embodiments.

FIG. 8 depicts an example of the travel service website once a travel service (e.g. a leg of a flight) has been selected, according to some embodiments.

FIG. 9 depicts an example screen shot of the travel-service website with travel service sharing functionalities, according to some embodiments.

FIG. 10 provides a screen shot with various user input fields related to booking a travel service/good, according to some embodiments.

FIG. 11 illustrates another view of a travel services/goods provider's web page, according to some embodiments.

FIG. 12 depicts an example web page wherein a user can input information to create a profile, according to some embodiments.

FIG. 13 illustrates an example process for ranking travel results according to user-specified travel preferences, according to some embodiments.

FIG. 14 depicts an example list of user-selected flight travel preference variables, according to some embodiments.

FIG. 15 illustrates an example process for weighting various flight information of a list of available flights according to a set of user of hierarchal travel preferences, according to some embodiments.

FIG. 16 illustrates an example process for calculating one or more weighted values for ranking travel results according to user-specified travel preferences, according to some embodiments.

FIG. 17 illustrates an example of a ranked list of flights that match a user's flight query, according to some embodiments.

FIG. 18 an example list of example possible flight travel preference variables that a user can select to include in list 1400, according to some embodiments.

FIG. 19 illustrates an example system for implementing an online travel service website, according to some embodiments.

FIG. 20 illustrates an example travel services server, according to some embodiments.

FIG. 21 is a block diagram of a sample computing environment that can be utilized to implement some embodiments.

FIG. 22 depicts an exemplary computing system that can be configured to perform any one of the processes provided herein.

The Figures described above are a representative set, and are not an exhaustive with respect to embodying the invention.

### DETAILED DESCRIPTION

Disclosed are a system, method, and article of manufacture of an online travel website. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Process Overview

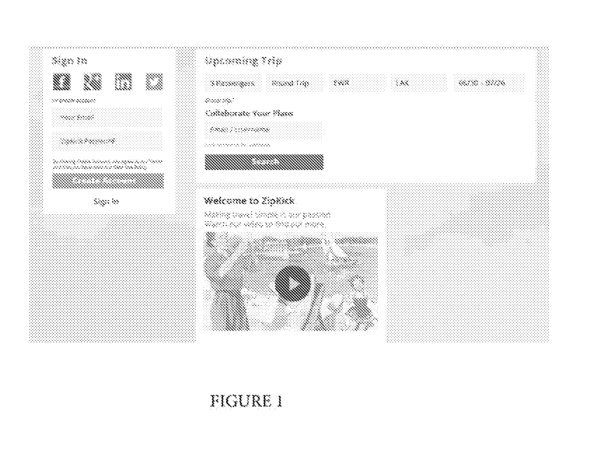

FIGS. 1-12 provide a series of exemplary screen shots depicting exemplary aspects of various embodiments. These screen shots are provided by way of example and not limitation. FIG. 1 depicts a screen shot illustrating an example web page of an online travel website. It is noted that additional commentary not integrated into the web page is signified by red arrows. The web page of FIG. 1 can include various fields for the input of user information. For example, a login/user authentication tool can be provided wherein a user can login with various user authentication methodologies. Alternatively, a user can login utilizing an online social networking service. The web page of FIG. 1 further provides a field for a user into put travel itinerary information (e.g. set of search criteria). A user can input information for more than one traveler (e.g. a user that books travel-related goods and/or services). For example, a first user can include her information as well as that of a second and/or third user. In this way, a group of users can automatically collaborate travel plans. The web page can include additional information such as access to tutorial videos and the like.

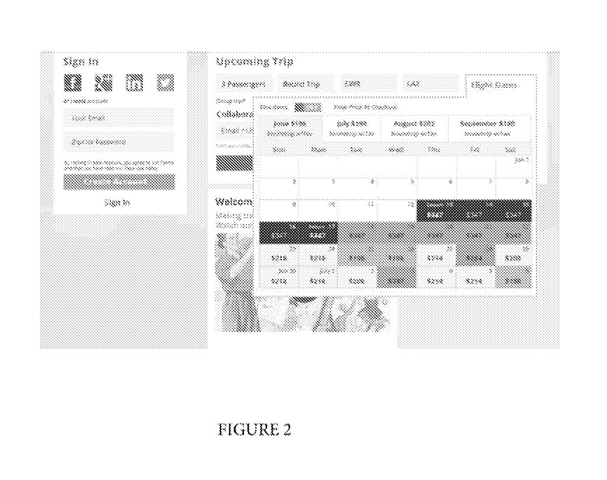

FIG. 2 depicts a screen shot of the web page of FIG. 1 with the ‘flight dates’ tab selected, according to some embodiments. A fare calendar (e.g. provides information about available air fares and associated pricing) can be provided when the ‘flight dates’ tab is selected. Additional information about the fare calendar popup is provided by the comments indicated in red and/or purple text with red arrows to the various relevant elements. For example, the fare calendar can include colored day elements indicating a ticket price grading (e.g. low, medium, high relative prices). It is noted that when a user logs into the travel service, the user can be requested to provide a hierarchy of travel-related preferences (e.g. top five preferences, top three preferences, etc.). These preferences can be used to weight the returned search results (see infra).

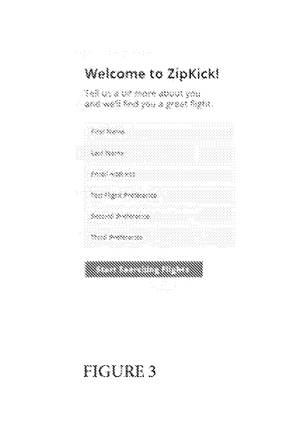

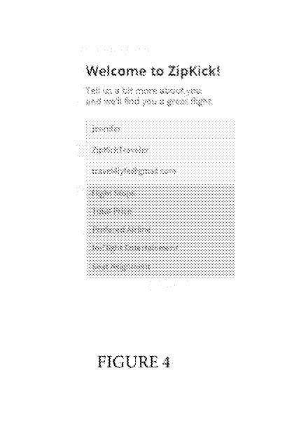

FIG. 3 depicts a screen shot of a web page providing input fields for a user to provide information including one or more user preferences related, according to some embodiments. User preferences (e.g. a hierarchal list) can include flight preferences. Examples of flight preferences can include, inter alia: number of stops, relative prices, type/medium of available in-flight entertainment, departure/arrival times, location of a seat on airplane, airline, airline baggage policies, travel dates, and the like. These user preferences can be utilized to weight, rank and sort returned travel options. Moreover, in the event, the user is travelling in a group, user preferences can be aggregated (e.g. averaged, weighted according user hierarchy in the group, etc.) to determine travel plans for the group as a unit. FIG. 4 provides an example of the inputs fields with a specific user's information, according to some embodiments. The travel service system can update the search results in the event the user preferences are modified. Additionally, a user can save a specified set of preferences to a user profile. A user can also save the search results of certain travel selections along with the user preferences associated with the search results. Search results can also be updated when the travel system detects changes to the database of available travel options (e.g. one or more flights are included). Preferences can also be set to automatically save to a user's profile. It is further noted that user can have multiple profiles. For example, a user can have a personal travel preference's profile that the user utilizes for personal travel. A user can also have a family related travel profile that the user uses for family trips. A user can further have a business profile that the user utilizes for work-related travel. In this example, an office administrator/executive assistant can be provided access to the user's business profile (e.g. the user's travel-related preferences for business trips), but not the user's various non-business related profiles. When multiple corporate employees are travelling together, the executive assistant can input multiple corporate user travel-preferences profiles to initiate a collaborative travel-service booking process.

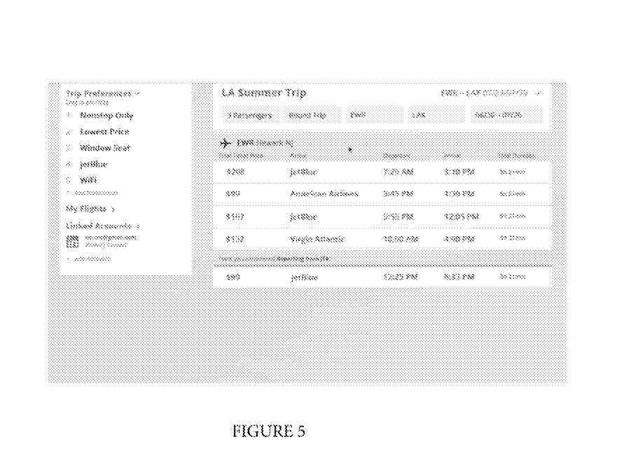

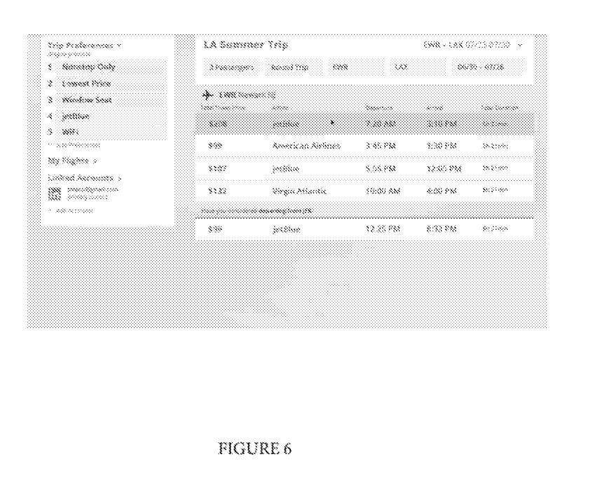

FIG. 5 and FIG. 6 depict an example of the web page of FIG. 1 with travel plan results provided according to the user(s) selections and/or preferences, according to some embodiments. Additional information about the fare calendar popup is provided by the comments indicated in red and/or black text with red arrows to the various relevant elements. These comments are provided by way of example and not of limitation. The search results can be based on a weighted value derived from the user(s) various travel preferences and their concomitant user-assigned rank. For example, a top-flight preference can have more weight than a second flight preference, which in turn, can have more weight than a third flight preference (e.g. see input fields of FIGS. 3 and 4). FIG. 5 also depicts a ‘Have You Considered’ feature. In addition, to the hierarchal preferences provided by the user, the ‘Have You Considered’ can further refine the search results based on additional factors (e.g. cost savings, other airport locations, etc.). One of more results can be ranked and sorted. A set of these results can be provided to the user. In some examples, third parties (e.g. airlines) can pay to have specified additional factors weighted greater to draw users to travel-related services/goods provided by the third party. In this way, results that benefit the third party can appear in the ‘Have You Considered’ section. Search criteria (e.g. a user's hierarchal preferences) can be modified ‘on the fly’ and the search results can be updated accordingly.

It is noted that other factors can be weighted and included in an algorithm to rank the search results (e.g. a user's travel history, user demographic details, etc.). Additionally, various information retrieval models can be implemented to obtain documents/files based on the user's travel services/goods query and/or the user's hierarchal preferences. An Information filtering system can be utilized to removes redundant or unwanted information from the search results by using (semi)automated and/or computerized methods prior to presentation to a human user. Additionally, search results, user queries, user hierarchal preferences and/or other user information can be represented in terms of a vector space model. The vector space model can be an algebraic model for representing objects, in general as vectors of identifiers, such as, for example, index terms. The vector space model can be used in information filtering, information retrieval, indexing and/or relevancy rankings aspects of the travel service system.

Moreover, in some examples, various search engine indexing techniques can be used to collect, parse, and/or store data to facilitate travel-related information retrieval. Indexing engines implement full-text indexing of online, natural language documents. Media types such as video and audio and/or graphics related to the travel services/goods can also be searchable. Meta search engines can reuse the indices of other services and may or may not store a local index. In some examples, a cache-based search engine can permanently store an index along with the corpus. Partial-text services can be utilized to restrict the depth indexed to reduce index size. Additionally, indexing can be performed at a predetermined time interval due to such factors as time and processing costs. Optionally, an agent-based search engines can index in real time.

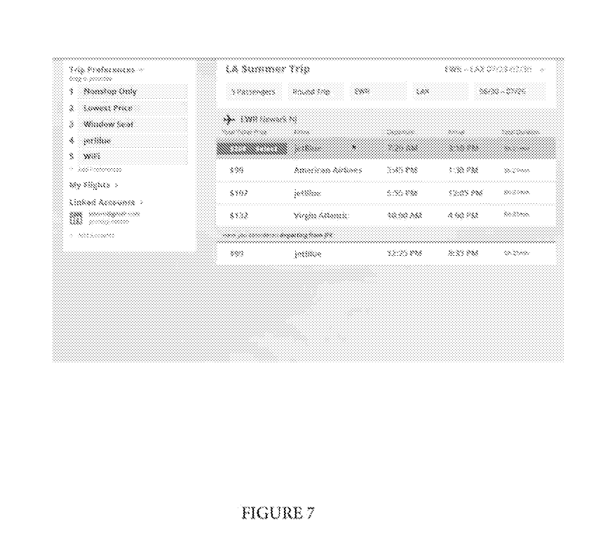

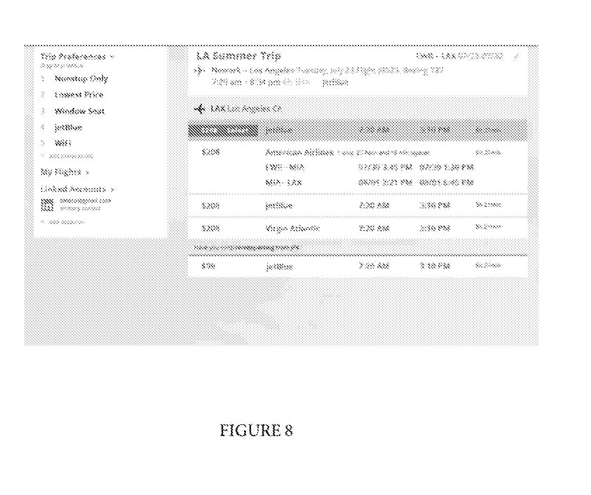

Returning now to FIG. 7, FIG. 7 depicts an example of a hover-over functionality of the travel-service website, according to some embodiments. A user can hover a pointer icon over a search result. The travel service can then present a list (and/or other means of indication such as highlighting, video graphics, and the like) of the relevant user's search criteria and/or hierarchal preferences that are associated with the particular search result. In this way, a user can verify which preferences are associated with various presented travel services/goods options. FIG. 8 depicts an example of the travel service website once a travel service (e.g. a leg of a flight) has been selected, according to some embodiments.

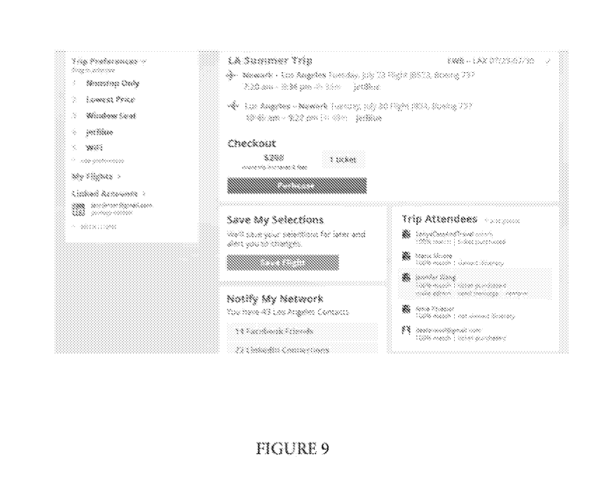

FIG. 9 depicts an example screen shot of the travel-service website with travel service sharing functionalities, according to some embodiments. A list of a user's social network connections and/or a set of other users collaborating on a travel service/good (e.g. a trip attendee list) can be made available to the user. The user can share any travel plans and/or travel-related information (e.g. user profile information, user hierarchal preferences, and the like) with other users in a list (e.g. with a drag and drop operation). In one example, as shown, a list of all trip attendees can be displayed. The status of each attendee with respect to the trip can also be displayed. In some examples, various user activities will be visible to the other users associated with the trip. Various fields can be provided wherein one user can communicate with anyone of the other users. For example, if a first user has not yet purchased an airplane ticket, a supervisor user can send a reminder to the first user via email, text message and/or other electronic communication protocol. Moreover, a functionality can be presented that enables the user to view and/or communicate with other members of a user's social network that are not in the list of attendees of the present travel service but somehow relevant to the travel service. For example, the travel service can obtain the user's social network contacts that live in the destination city of an airline flight. Additionally, fields can be provided that enable a user to invite (e.g. a social networking message, email, microblog posting, etc.) social networking contacts to become trip attendees. The invitee's information can appear in the attendee list once the invitee accepts the invitation. It is noted that each attendee's hierarchal preferences can be made available to the user. Various information about the relationship of the other attendees' hierarchal preferences and the travel service, such as a percentage of matches between a particular flight and the hierarchal preferences, can also be provided. In this way, various attendees can collaborate based on the relevant hierarchal preferences of each attendee. In some examples, the hover over to display hierarchal preferences can be expanded to include the relevant hierarchal preferences of one or more attendees (and/or can be aggregated and sorted for the group of attendees).

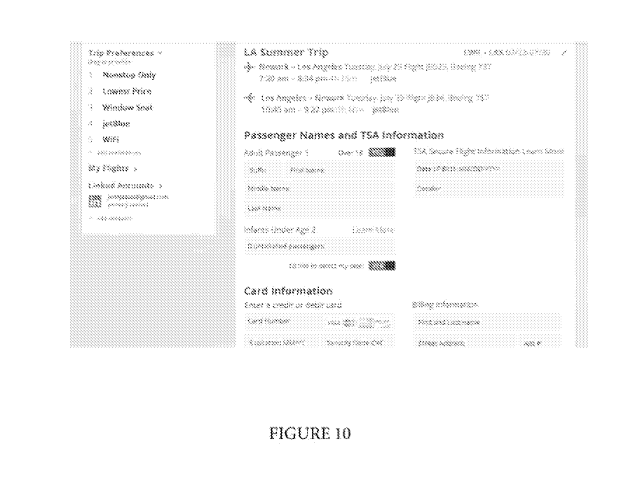

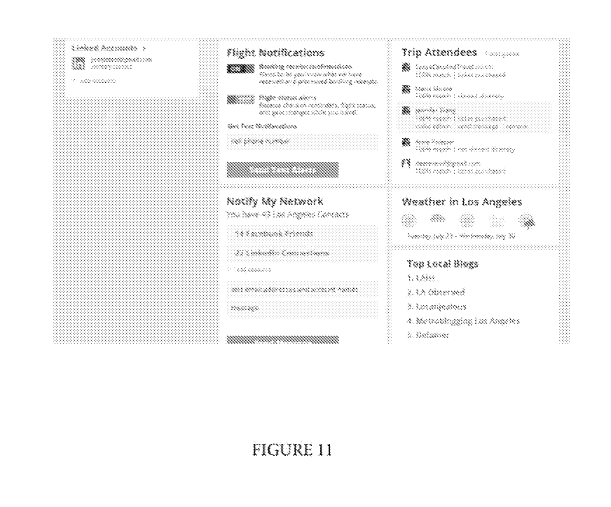

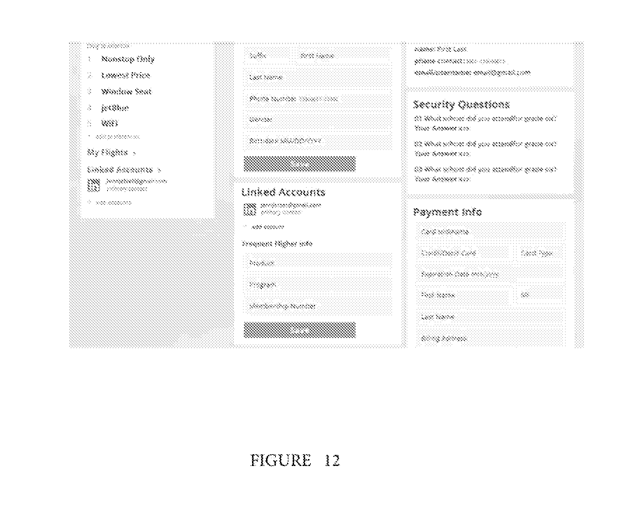

FIG. 10 provides a screen shot with various user input fields related to booking a travel service/good, according to some embodiments. FIG. 11 illustrates another view of a travel services/goods provider's web page, according to some embodiments. FIG. 12 depicts an example web page wherein a user can input information to create a profile, according to some embodiments.

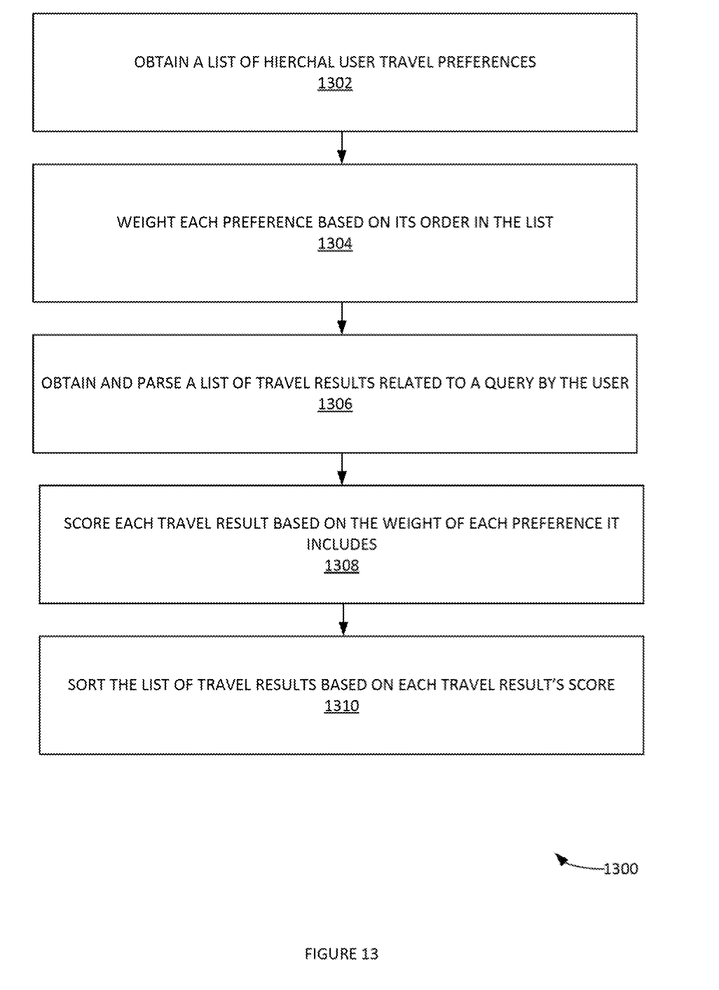

FIG. 13 illustrates an example process 1300 for ranking travel results according to user-specified travel preferences, according to some embodiments. Various algorithms can be utilized (e.g. solely and/or in combination) to rank and sort travel search results according to the user(s) provided preferences. Process 1300 provides an example algorithm to rank travel results based on hierarchal user travel preferences (e.g. flight cost, window seat, aisle seat, and/or airline). In step 1302, a user can input these travel preferences into a web page field(s) (e.g. see FIGS. 3 and 4). In step 1304, the index of each travel preferences can be used to provide its weight. In one example, each travel preference can be represented as an element of a vector and assigned a numeric value. For example, a first travel preference can be a window seat and a second travel preference can be in-flight Wi-Fi networking availability. Accordingly, a window seat option can be assigned a greater weight than an in-flight Wi-Fi option. A user can provide a query for a travel service (e.g. a flight query). In step 1306, a list of travel results related to a query provided by the user can be obtained. Each travel result can be parsed to identify the various attributes and options associated with the particular travel result. Attributes and options associated with elements of the user user-specified travel preferences list can be identified. In step 1308, each travel result can be scored based on the weight of each user-specified travel preference it includes. For example, the flight with the window seat can be scored higher than the flight with in-flight Wi-Fi. In step 1310, the list of travel results can be sorted based on each travel result's score. The sorted list of travel results can then be displayed on a web page and/or mobile device client application.

User hierarchal preferences, search-result travel services and/or queries can be represented as vectors. For example:

dⱼ=(w_{1,j}, w_{2,j}, . . . w_{t,j})

q=(w_{1,q}, w_{2,q}, . . . , w_{t,q})

Where a q-term represents a set of user hierarchal preferences and a d-term represents a travel service (there can be multiple d terms based on a number of search results). Each dimension corresponds to a separate term. If a term occurs in the travel service, its value in the vector is non-zero. Several different ways of computing these values, also known as (term) weights, can be implemented. One example schemes can include term frequency-inverse document frequency (tf-idf) weighting. This methodology is provided by way of example and not of limitation. Other methods of weighting, scoring and sorting travel service search results can be implemented in other example embodiments.

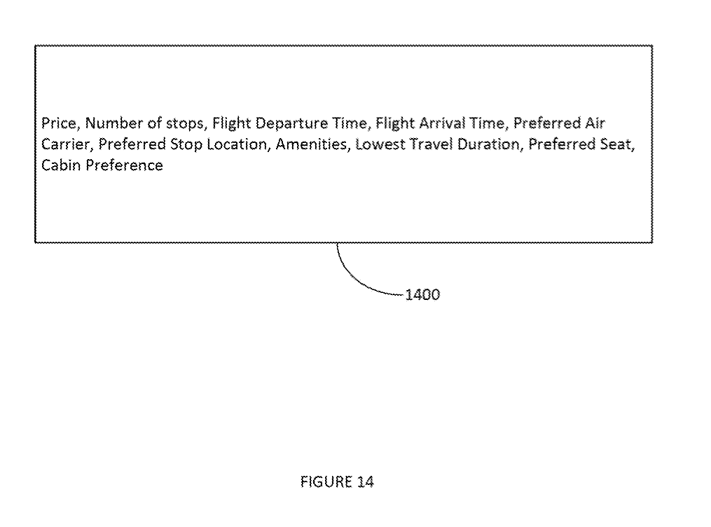

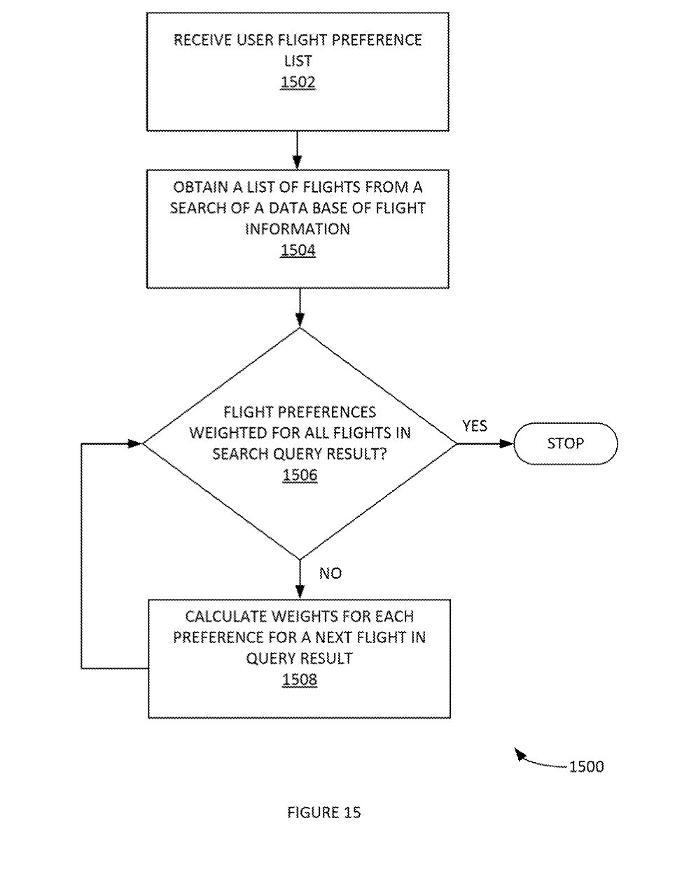

Various data sets created during process 1300 can be provided to other functionalities of an online travel service. For example, attributes and options associated with elements of the user user-specified travel preferences list can be identified and provided to a functionality that lists the user preferences of a travel service when the user hovers a pointing device (e.g. a mouse pointer icon, a finger, looking at the element with an eye-tracker, etc.). Moreover, the data sets created during process 1300 can be migrated to other applications that aggregate this information for multiple users. Process 1300 can be used to implement any of the examples of FIGS. 1-12 supra. In some examples, process 1300 and any of the examples of FIGS. 1-12 can be implemented with the systems and modules of FIGS. 14 and 15.

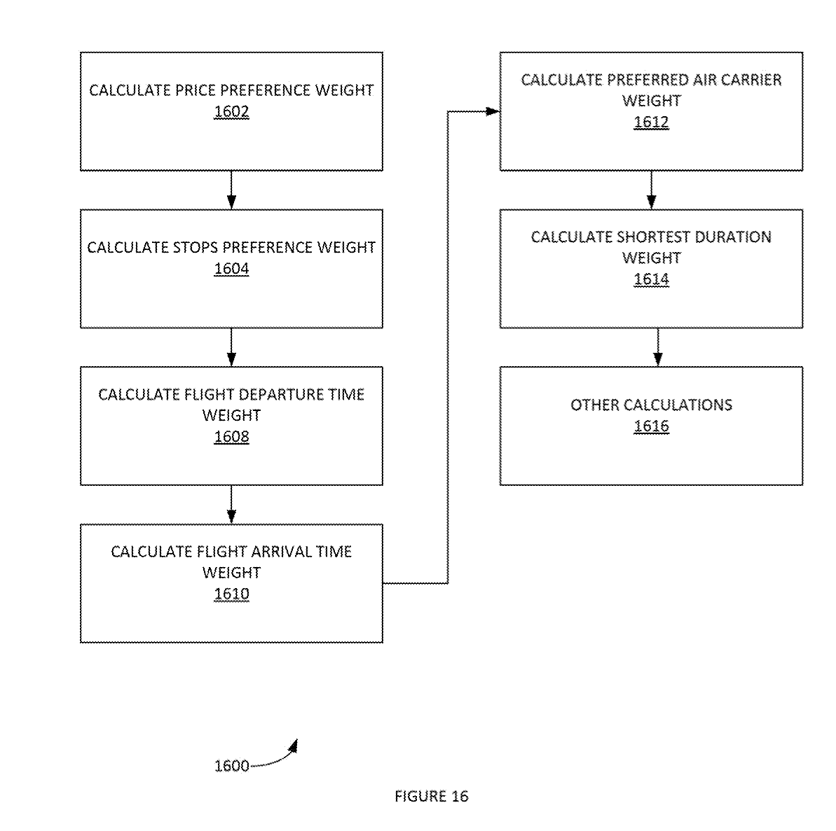

FIG. 14 depicts an example list 1400 of user-selected flight travel preference variables, according to some embodiments. The various elements of list 1400 can be associated with values for each flight in a list of flights that matches a user flight search. The list of flights can be obtained by a search engine functionality in a server that queries a flight and/or other travel services database. For example, the database can be a third-party global distribution system (GDS) and/or a commercial reservation system application process interface (API). As used herein, the GDS can be a network operated by a company that enables automated transactions between Vendors and/or booking agents in order to provision travel related services to the end consumers. A GDS can link services, rates and/or bookings consolidating products and services across all three travel sectors (e.g. airline reservations, hotel reservations, car rentals, and/or other travel-related activities). The value of each element of list 1400 can also be weighted (e.g. per process 1600 of FIG. 16 provided infra). The weighting can be based, inter alia, on user of hierarchal travel preferences.

FIG. 15 illustrates an example process 1500 for weighting various flight information of a list of available flights according to a set of user of hierarchal travel preferences, according to some embodiments. In step 1502, a user's flight list preferences can be received. In step 1504, a list of flights from a search of a database of flight information can be obtained. In step 1506, it can be determined if the flight preferences have be weighted for all flights in the search query result. If yes, process 1500 can stop. If no, then process 1500 can proceed to step 1508. In step 1508, the weight for each preference in a next flight in a query result list can be calculated. Process 1500 can then return to step 1506.

FIG. 16 illustrates an example process 1600 for calculating one or more weighted values for ranking travel results according to user-specified travel preferences, according to some embodiments. While weighted values for flight preferences are provided n the particular example of FIG. 16, it is noted that process 1600 can be adapted to other travel-related vertical markets for ranking travel results according to user-specified travel preferences (e.g. car rental results, hotel results, spa treatment results, etc.). In step 1602, a price preference weight can be calculated. For example, the spreadsheet formula (e.g. an Excel® spreadsheet formula) of ‘((WEIGHT 1000 (+OR−25%))−(Current Flight Price−(Lowest Priced Flight Available))*2’ can be used to calculate the price preference weight. In step 1604, a stops preference weight can be calculated. For example, the spreadsheet formula of ‘((WEIGHT 450 (+OR−25%))−(Current flight number of stops−(lowest number of stops on all flights available))*150)’ can be used to calculate the stops preference weight. In step 1606, a price preference weight can be calculated. For example, the spreadsheet formula of ‘((WEIGHT 1000 (+OR−25%))−(Current Flight Price−(Lowest Priced Flight Available))*2’ can be used to calculate the price preference weight. In step 1608, a flight departure time weight can be calculated. For example, the spreadsheet formula of ‘((WEIGHT 1000 (+OR−25%))−((Absolute Value(((Current flights departure time−Integer(Current flights departure time))*24)−Earliest preferred flight departure time)*60)))’ can be used to calculate the flight departure time weight. In step 1610, a flight arrival time weight can be calculated. For example, the spreadsheet formula of ‘((WEIGHT 1000 (+OR−25%))−((Absolute Value(((Current flights Arrival time−Integer(Current flights Arrival time))*24)−Earliest preferred flight Arrival time)*60)))’ can be used to calculate the flight arrival time weight. In step 1612, a preferred air carrier weight can be calculated. In step 1614, a shortest duration weight can be calculated. For example, the spread sheet formula of ‘((WEIGHT 1000 (+OR−25%))−(((CURRENT FLIGHT DURATION−SHORTEST AVAILABLE DURATION))/0.0166666)*5)’ can be used to calculate the shortest duration weight. In step 1616, other calculations can be performed. For example, additional flight and/or other travel preferences can be weighted. In step 1616, a total score can be summed from the results of the previous steps of process 1600. It is note that the various values and percentages of the various spread sheet formula examples provided can be modified based on a variety of factors. For example, a system administrator can modified specified values. In another example, the values can be based upon a user provided preference ranking (e.g. from the list of hierarchal travel preferences obtained in step 1302 of FIG. 13).

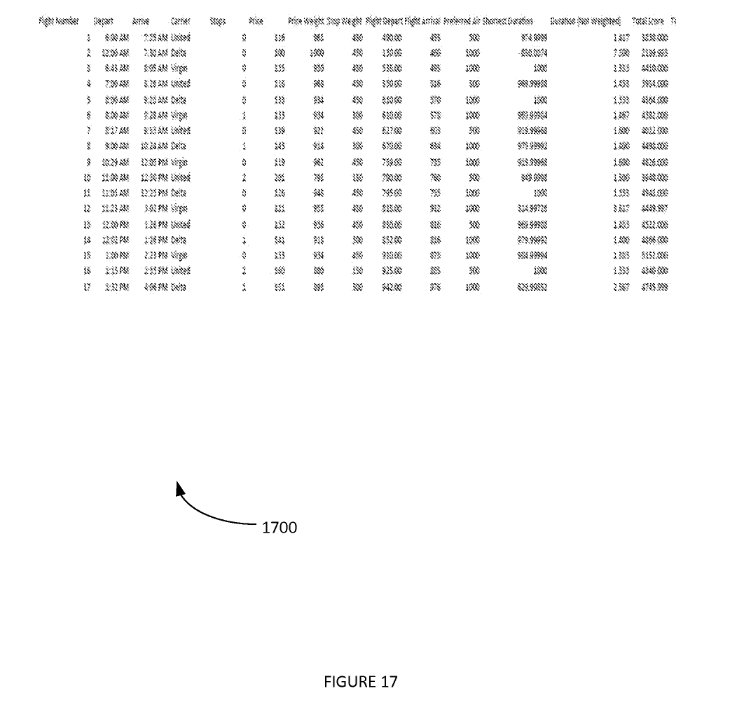

FIG. 17 illustrates an example of a ranked list of flights 1700 that match a user's flight query, according to some embodiments. The ranked list of flights 1700 can be ranked by implementing processes 1300, 1500 and/or 1700 on a set of flights retrieved using a search query of flight information provided by a user. The ranked list of flights 1700 can be ranked based on a total score calculated by a sum of weighted flight preferences. It is noted that ranked list of flights 1700 can also be sorted based on the preferences of other travelers travelling with a user (e.g. a co-worker, a supervisor, a relative, etc.). In this way, in some examples, ranked list of flights 1700 can ranked according to the preferences of multiple users. In the multiple user example, certain user preferences can be provided greater weight than other co-travelers. For example, a supervisor's flight preferences can be provided a double weight than a lower tiered employee travelling in the group. A corporate hierarchy database can be consulted to determine the weights of users in a travel group. The weighted scores of the various flight attributes for each individual flight are also provided in ranked list of flights 1700.

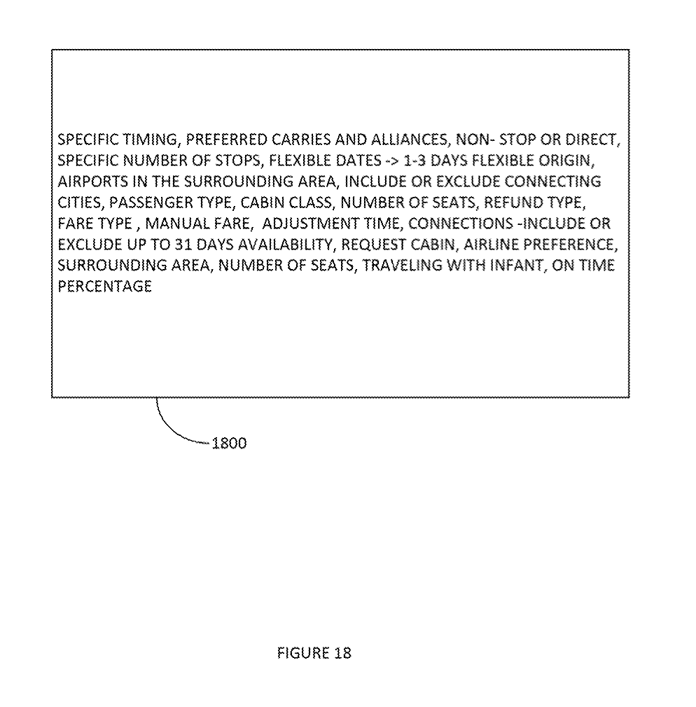

FIG. 18 an example list 1800 of example possible flight travel preference variables that a user can select to include in list 1400, according to some embodiments. It is noted that additional flight travel preferences can be used in other example preferences. Moreover, the list of flight travel preference variables can be combined with other travel-related preference variables in other example embodiments (e.g. hotel preference variables, car rental preference variables, etc.).

Exemplary Environment and Architecture

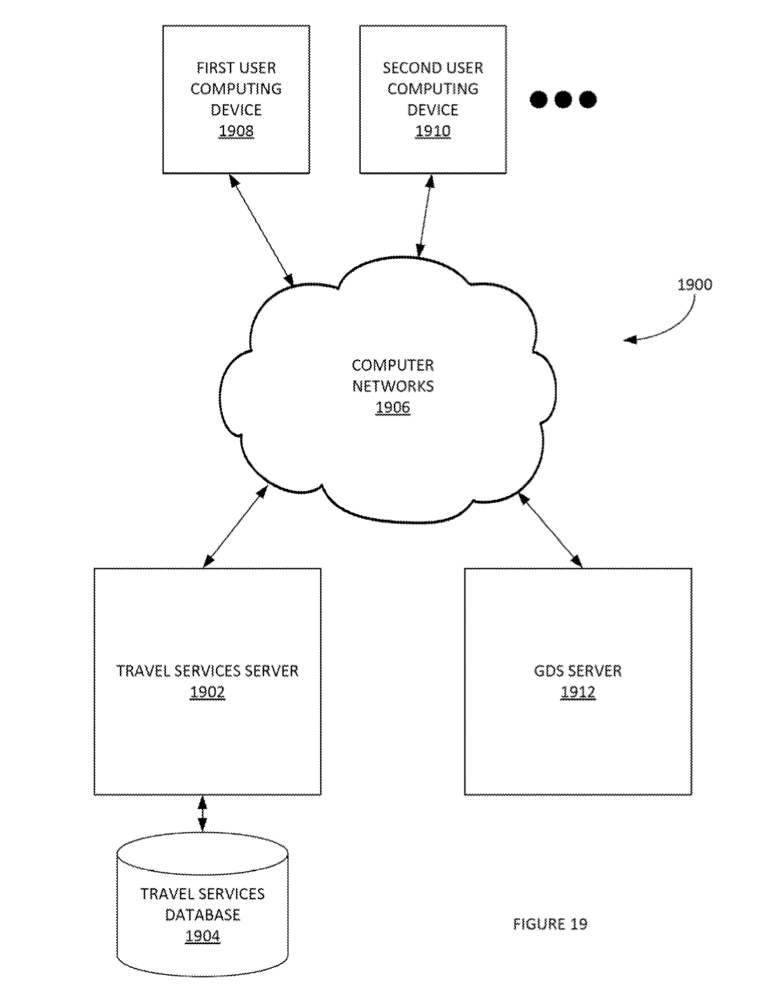

FIG. 19 illustrates an example system 1900 for implementing an online travel service website, according to some embodiments. System 1900 can include a travel services server 1902. Travel services server 1902 can include various functionalities for implementing an online travel service website. For example, travel services server 1902 can include a web server functionality. Travel services server 1902 can include a search engine functionality. Travel services server 1902 can include a functionality for communicating with and/or managing client applications in user computing devices 1908 and/or 1910. Travel services server 1902 can include functionalities for implementing processes and systems of FIGS. 1-18. Travel services server 1902 can provide queries to GDS server 1912 and/or other third party servers with travel-related information (e.g. hotel booking entity servers, car rental enterprise servers, spa treatment entity servers, etc.). Communication in system 1900 can be performed via computer network(s) 1906.

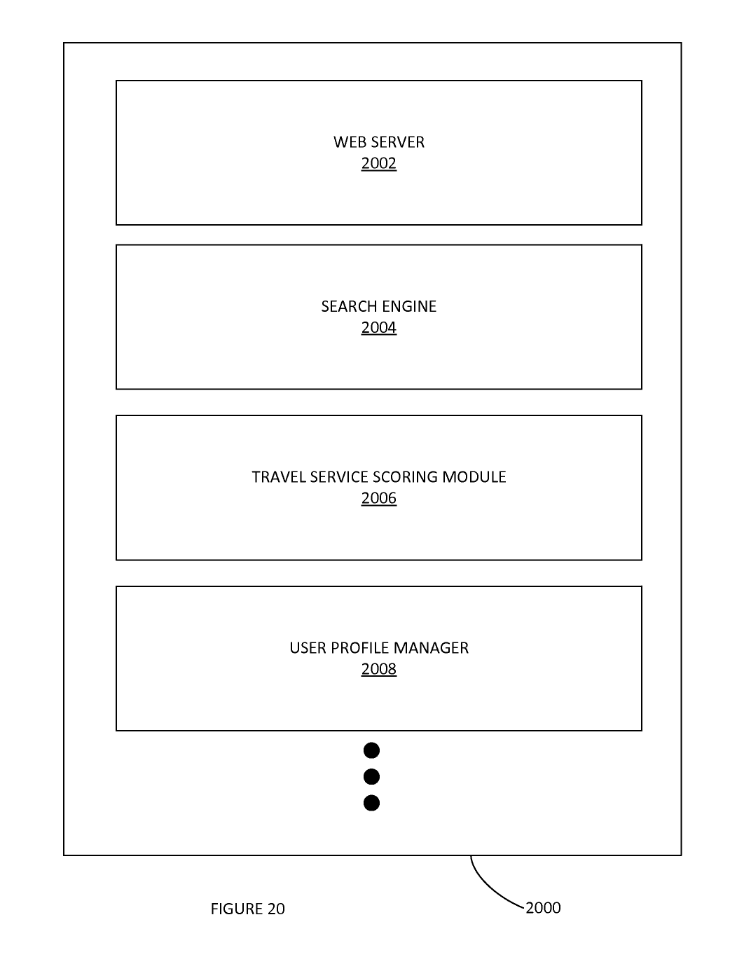

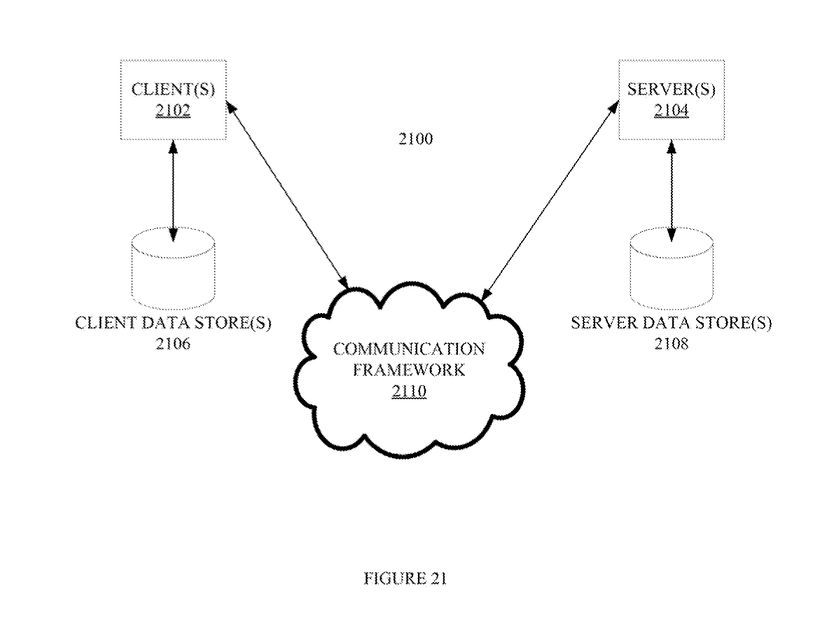

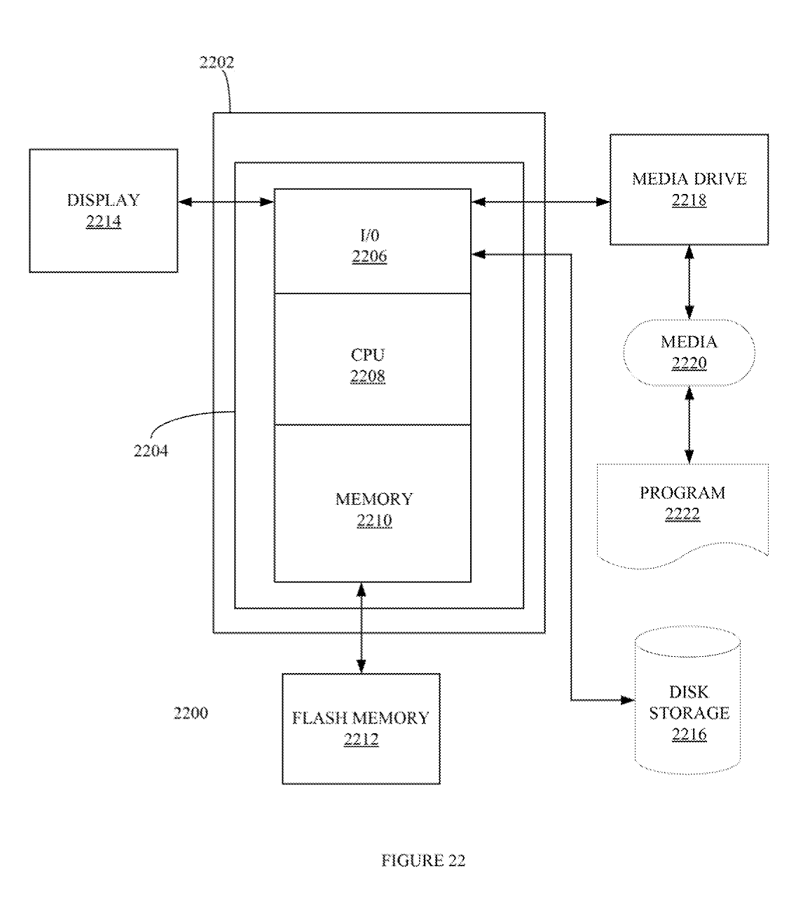

FIG. 20 illustrates an example travel services server 2000, according to some embodiments. Travel services server 2000 can perform the functionalities of travel services server 1902, as well as those provided in the systems and process of FIGS. 1-21. For example, travel services server 2000 can include a web server 2002. Web server 2002 can include can refer to either the hardware (the computer) or the software (the computer application) that helps to deliver web content that can be accessed through the Internet. Search engine 2004 software system that is designed to search for information on the World Wide Web and/or other database systems. Travel services scoring module 2006 can implement process 1300, 1500 and/or 1600 (as well as any processes provided for in FIGS. 1-12). User profile manager 2008 can enable various users to upload, store and/or manage various user profile information. For example, users can store profiles that include various travel-related preferences. Users can have multiple travel-related service profiles (e.g. a personal profile, a family profile, a work-related profile, etc.). Travel services server 2000 can include other functionalities that are provided in FIGS. 1-19 and/or FIGS. 21-22.

FIG. 21 is a block diagram of a sample computing environment 2100 that can be utilized to implement some embodiments. The system 2100 further illustrates a system that includes one or more client(s) 2102. The client(s) 2102 can be hardware and/or software (e.g., threads, processes, computing devices). The system 2100 also includes one or more server(s) 2104. The server(s) 2104 can also be hardware and/or software (e.g., threads, processes, computing devices). One possible communication between a client 2102 and a server 2104 may be in the form of a data packet adapted to be transmitted between two or more computer processes. The system 2100 includes a communication framework 2110 that can be employed to facilitate communications between the client(s) 2102 and the server(s) 2104. The client(s) 2102 are connected to one or more client data store(s) 2106 that can be employed to store information local to the client(s) 2102. Similarly, the server(s) 2104 are connected to one or more server data store(s) 2108 that can be employed to store information local to the server(s) 2104.

In some embodiments, system 2100 can be include and/or be utilized by the various systems and/or methods described herein to implement processes 100, as well as other processes. For example, the specified content of processes 1300, 1500, 1600 and/or FIGS. 1-12, 17 and/or 18 can be stored in 2106 and/or 2108. User login verification can be performed by server 2104. Client 2102 can be in an application (such as a web browser, augmented reality application, text messaging application, email application, instant messaging application, etc.) operating on a computer such as a personal computer, laptop computer, mobile device (e.g. a smart phone) and/or a tablet computer. In some embodiments, computing environment 2100 can be implemented with the server(s) 2104 and/or data store(s) 2108 implemented in a cloud computing environment.

FIG. 22 depicts an exemplary computing system 2200 that can be configured to perform any one of the processes provided herein. In this context, computing system 2200 may include, for example, a processor, memory, storage, and I/O devices (e.g., monitor, keyboard, disk drive, Internet connection, etc.). However, computing system 2200 may include circuitry or other specialized hardware for carrying out some or all aspects of the processes. In some operational settings, computing system 2200 may be configured as a system that includes one or more units, each of which is configured to carry out some aspects of the processes either in software, hardware, or some combination thereof.

FIG. 22 depicts computing system 2200 with a number of components that may be used to perform any of the processes described herein. The main system 2202 includes a motherboard 2204 having an I/O section 2206, one or more central processing units (CPU) 2208, and a memory section 2210, which may have a flash memory card 2212 related to it. The I/O section 2206 can be connected to a display 2214, a keyboard and/or other user input (not shown), a disk storage unit 2216, and a media drive unit 2218. The media drive unit 2218 can read/write a computer-readable medium 2220, which can contain programs 2222 and/or data. Computing system 2200 can include a web browser. Moreover, it is noted that computing system 2200 can be configured to include additional systems in order to fulfill various functionalities. In another example, computing system 2200 can be configured as a mobile device and include such systems as may be typically included in a mobile device such as GPS systems, gyroscope, accelerometers, cameras, augmented-reality systems, etc. In one example, the system of FIG. 22 can be utilized to implement processes 1300, 1500, 1600 and the examples of FIGS. 1-12, 17 and/or 18.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of an online travel website comprising:
obtaining a list of hierarchal user travel preferences from a first user;
weighting each of the first user's travel preference based on an order of the first user's travel preference in the list;
receiving a first user's query for a list of travel results;
obtaining the list of travel results related to the first user's query;
parsing the list of travel results to identify a travel result attribute related to each of the first user's travel preferences;
scoring each travel result based on the weight of each related first user's travel preference; and
sorting the list of travel results based on a score of each travel result.

2. The method of claim 1, further comprising:
obtaining a list of hierarchal user travel preferences from a second user; and
weighting each of the second user's travel preference based on an order of the second user's travel preference in the list.

3. The method of claim 2, further comprising:
parsing the list of travel results to identify a travel result attribute related to each of the second user's travel preferences.

4. The method of claim 3, wherein the step of scoring each travel result based on the weight of each related first user's travel preference associated further comprises:
scoring each travel result based on the weight of each related first user's travel preference and each related second user's travel preference.

5. The method of claim 4, wherein the first user comprises a higher ranking employee than the second user.

6. The method of claim 5, wherein the first user's travel preferences receive a greater weight than the second user's travel preferences.

7. The method of claim 6, further comprising:
detecting that the first user has moved a computer-implemented pointer over a graphical display of an element of the list of travel results.

8. The method of claim 7, further comprising:
generating a hover box that comprises a first set of one or more hierarchal user travel preferences from the first user that are associated with the element of the list of travel results when it has been detected that the first user has moved a computer-implemented pointer over a graphical display of an element of the list of travel results.

9. The method of claim 8, wherein the hover box further comprises a second set of travel result scores that are associated with the element of the list of travel results.

10. The method of claim 9, wherein the hover box further comprises a third set of one or more hierarchal user travel preferences from the second user that are associated with the element of the list of travel results.

11. A computerized system comprising:
a processor configured to execute instructions;
a memory containing instructions when executed on the processor, causes the processor to perform operations that:
receives a list of hierarchal user travel preferences from a first user;
weights each of the first user's travel preference based on an order of the first user's travel preference in the list;
receives a first user's query for a list of travel results;
obtains the list of travel results related to the first user's query;
parses the list of travel results to identify a travel result attribute related to each of the first user's travel preferences;
scores each travel result based on the weight of each related first user's travel preference; and
sorts the list of travel results based on a score of each travel result.

12. The computerized system of claim 11, wherein the memory further comprises instructions when executed on the processor, causes the processor to perform operations that:
obtain a list of hierarchal user travel preferences from a second user; and
weight each of the second user's travel preference based on an order of the second user's travel preference in the list.

13. The computerized system of claim 12, wherein the memory further comprises instructions when executed on the processor, causes the processor to perform operations that:
parse the list of travel results to identify a travel result attribute related to each of the second user's travel preferences; and
scores each travel result based on the weight of each related first user's travel preference and each related second user's travel preference.

14. The computerized system of claim 13, wherein the memory further comprises instructions when executed on the processor, causes the processor to perform operations that:
detects that the first user has moved a computer-implemented pointer over a graphical display of an element of the list of travel results; and
generates a hover box that comprises a first set of one or more hierarchal user travel preferences from the first user that are associated with the element of the list of travel results when it has been detected that the first user has moved a computer-implemented pointer over a graphical display of an element of the list of travel results.

15. The computerized system of claim 14, wherein the hover box further comprises a second set of travel result scores that are associated with the element of the list of travel results.

16. The computerized system of claim 14, wherein the hover box further comprises a third set of one or more hierarchal user travel preferences from the second user that are associated with the element of the list of travel results.
